(19) United States
(12) Patent Application Publication
(10) Pub. No.: US 2022/0040709 A1
(43) Pub. Date: Feb. 10, 2022

(54) CONNECTION CONSTRUCTION

(71) Applicant: Eppendorf AG, Hamburg (DE)

(72) Inventor: Steffen Kühnert, Leipzig (DE)

(73) Assignee: Eppendorf AG, Hamburg (DE)

(21) Appl. No.: 17/414,369

(22) PCT Filed: Dec. 16, 2019
(86) PCT No.: PCT/EP2019/085455

§ 371 Date: Jun. 16, 2021

(30) Foreign Application Priority Data
Dec. 18, 2018 (EP) 18213729.9

(51) Int. Cl. B04B 9/08

(52) U.S. Cl. CPC B04B 9/08; B04B 2009/085

(57) ABSTRACT

A connection construction (100) between a centrifuge rotor (102) and a drive shaft (104) of a laboratory centrifuge (200) allows one-handed operation that does not require any additional tools. The connection construction (100) is designed such that the locking mechanism (118, 132, 134) is constantly guaranteed, preventing the jamming or blocking of the locking elements (118, 134).

### CROSS-REFERENCE TO RELATED APPLICATION

This application is a national stage application, filed under 35 U.S.C. § 371, of International Patent Application No. PCT/EP2019/085455, filed on Dec. 16, 2019, which claims the benefit of European Patent Application No. 18213729.9, filed Dec. 18, 2018.

### TECHNICAL FIELD

The present disclosure relates to a connection construction between a centrifuge rotor and a drive shaft of a centrifuge motor.

### BACKGROUND

Centrifuge rotors are used in centrifuges, in particular laboratory centrifuges, to separate the components of samples centrifuged therein by utilizing mass inertia. Increasingly higher rotation speeds are used to achieve high segregation rates. Laboratory centrifuges are centrifuges whose centrifuge rotors operate at preferentially at least 3,000, preferably at least 10,000, in particular at least 15,000 revolutions per minute, and are usually placed on tables. In order to be able to place them on a worktable, they have a form factor of less than 1 m×1 m×1 m in particular, so their installation space is limited. Preferably, the unit depth is limited to max. 70 cm. However, laboratory centrifuges that are formed as standing centrifuges are also known; that is, they have a height in the range of 1 m to 1.5 m, so that they can be placed on the floor of a room.

Such centrifuges are used in the fields of medicine, pharmacy, biology and chemistry.

The samples to be centrifuged are stored in sample containers and such sample containers are rotationally driven by means of the centrifuge rotor. In this process, the centrifuge rotors are typically set in rotation by means of a vertical drive shaft driven by an electric motor. The coupling between the centrifuge rotor and the drive shaft is typically made by means of the hub of the centrifuge rotor.

There are different centrifuge rotors that are used depending on the application. The sample containers can contain the samples directly or separate sample receptacles that contain the sample are inserted in the sample containers, such that a large number of samples can be centrifuged simultaneously in one sample container. In general, centrifuge rotors are known in the form of fixed-angle rotors and swing-out rotors and others.

The connection construction between such centrifuge rotors and the drive shafts of the centrifuge motors, which ensures the locking of the respective centrifuge rotor on the drive shaft during the operation of the centrifuge, is mostly universal regardless of the type of centrifuge rotor, such that different types of centrifuge rotors can be used in the same centrifuge without any problems.

Such connection constructions are typically formed in such a manner that there is a screw connection between the centrifuge rotor and the shaft, whereby a highly secure and durable connection can be established. A key is required to lock and release the connection; with this, the screw connection can be operated. The disadvantage of this connection construction is that, with the key, additional elements that can be mislaid are required; in addition, one-handed operation is not possible.

However, using an automatic lock that allows one-handed operation is also known at this time. This system is marketed, for example, by the company Sigma Laborzentrifugen GmbH, An der Unteren Söse 50, 37520 Osterode am Harz, under the name “G-Lock®.” A disadvantage of this, however, is that a complex redirection of centrifugal forces acting on eccentric elements to coupling elements takes place, which can be subject to numerous error pronenesses in both locking and unlocking, which can ultimately make the operation of such coupling device unsafe in everyday use.

### SUMMARY

It is therefore the object of the present disclosure to at least partially overcome such disadvantages. Preferably, one-handed operation, for which no additional tool is required, is to be made possible. In particular, the connection construction is to be constructed in such a manner that locking is always ensured, whereby the jamming or blocking of locking elements cannot occur.

This object is achieved with the connection construction as claimed. Advantageous further developments are indicated in the subclaims and in the following description together with the figures.

On the part of the inventor, it was recognized that this object can be achieved in a surprisingly simple manner if there is an actuating means on one of the elements, the drive shaft and the centrifuge rotor, which makes the locking mechanism releasable, because this enables true one-handed operation and the actuating means also effectively prevents the jamming or the like of the locking elements.

The connection construction between a centrifuge rotor and a drive shaft of a centrifuge motor extending along a shaft axis, wherein a first locking element is arranged on one of the elements of centrifuge rotor and drive shaft and a second locking element is arranged on the other of the elements of centrifuge rotor and drive shaft, wherein the first locking element is engaged with the second locking element in the locked state of the connection and is disengaged in the unlocked state, is characterized in that there is an actuating means on one of the elements of centrifuge rotor and drive shaft, the actuation of which causes the first locking element to disengage from the second locking element, by which the centrifuge rotor is removable from the drive shaft.

In an advantageous further development, it is provided that the first locking element is a lever. This makes locking particularly easy to manage. If the lever arm of the lever can be moved in a plane parallel to the shaft axis, the connection construction can be formed to be particularly slim. This is even more so if the lever arm is movable in a plane that includes the shaft axis. In this context, “lever arm” means the part of the lever that enters into the locked state with the second locking element.

In an advantageous further development, it is provided that the lever is mounted so that it can pivot about an axis. This makes the lever function particularly easy to implement.

In an advantageous further embodiment, the lever has an actuating arm that is arranged opposite the lever arm, wherein the axis is preferably arranged between the lever arm and the actuating arm. Then, the lock is particularly easy to operate.

In an advantageous further development, it is provided that the distance of an outer point of the actuating arm from the axis is greater than or equal to the distance of a locking point of the lever arm from the axis. The “locking point” in this case is a point at which the first locking element rests against the second locking element in the locked state. This design allows the lock to be released particularly securely, because there is a lever ratio of at least 1 between the actuating arm and the lever arm.

In an advantageous further embodiment, it is provided that the first locking element is formed such that it engages with the second locking element under the influence of centrifugal force. As a result, locking takes place automatically during the operation of the centrifuge. Preferably, the center of mass of the first locking element is located in the actuating lever and, in particular, behind the axis with respect to the shaft axis, because self-locking caused by centrifugal force is then implemented in a particularly simple design.

Alternatively or additionally, it can be provided that the first locking element is preloaded in the direction of engagement with the second locking element. This allows the locking to take place already without centrifugal force, that is, automatically without regard to the operating state of the centrifuge. At the same time, the preloading can also serve as a preloading for the actuating means, wherein, however, a separate preloading is preferably provided for the actuating means. If the preloading is used in addition to the centrifugal force, then a reinforcement of the locking by the centrifugal force takes place due to the rotation of the centrifuge rotor.

In an advantageous further development, it is provided that the actuating means has a contact surface for a mating contact surface of the first locking element, wherein one of the two surfaces of contact surface and mating contact surface has an inclined course in the actuating direction of the actuating means, at least in the locked state of the connection construction, in such a manner that the actuation of the actuating means causes the first locking element to pivot. This makes unlocking particularly easy to achieve.

In an advantageous further development, it is provided that the contact surface runs in a manner inclined in the axial direction of the shaft axis. This makes it very easy to unlock levers that can be pivoted about an axis, for example. The mating contact surface will then preferably be straight in the direction of the shaft axis, but can also have a slope, which must, however, be dimensioned so that an unlocking force is exerted on the first locking element when the actuating means is displaced in the actuating direction.

In an advantageous further development, it is provided that the contact surface has a slope in the range of 20° to 70°, preferably in the range of 30° to 60°, in particular in the range of 35° to 55°, preferentially of 45° with respect to the shaft axis W, because this enables a large force transmission with short actuating travels of the actuating means.

In an advantageous further embodiment, it is provided that the contact surface runs in a manner facing the shaft axis W, because the connection construction can then be kept highly compact.

In an advantageous further development, it is provided that the actuating means is formed to be sleeve-like at least in certain areas, wherein the contact surface preferably is arranged on an inner side of the actuating means. “Sleeve-like at least in certain areas” means that the sleeve shape can be only partially formed with respect to the circumferential direction, but also with respect to the axial direction along the shaft axis. For example, individual cylinder segments can exist as bars in the axial direction in the circumferential direction, or the sleeve shape exists only over a certain axial range and is adjoined by a hemispherical shape or the like. Preferably, the sleeve shape is continuous in the circumferential direction, because then the actuating element need not be fixed in its azimuthal position with respect to the first locking elements.

In an advantageous further development, it is provided that the actuating means can be actuated along an actuating path, wherein the contact surface is formed such that the mating contact surface bears against it during the entire actuating path. This achieves a very secure unlocking and avoids malfunctions.

In an advantageous further development, it is provided that the actuating means is formed as a push button that is preloaded against the actuating direction. This makes unlocking particularly easy and ergonomic.

In an advantageous further development, it is provided that the first locking element is arranged on the centrifuge rotor. This allows the essential elements to be arranged in the centrifuge rotor, preferably its hub, which improves durability because the drive shaft itself, in particular, does not have to have moving parts for the connection construction.

In an advantageous further development, it is provided that the second locking element is a projection of the drive shaft, behind which the first locking element engages in the locked state. Thereby, the connection construction is structured to be particularly simple.

In an advantageous further development, it is provided that the actuating means exists on the centrifuge rotor. Thereby, the drive shaft can be designed to be compact. Alternatively, however, the actuating means could also exist on the drive shaft.

In an advantageous further development, it is provided that there are at least two first locking elements, preferably three first locking elements. This makes the lock particularly secure.

In an advantageous further development, it is provided that the connection construction provides a snap-in connection, wherein the locking takes place within the framework of a clip connection, which is designed to be releasable. This makes the locking mechanism particularly secure, and the user can hear the locking mechanism click into place, making it very easy to verify the security provided. Preferably, to provide the snap-in connection, there would be a preloading of the first connecting element in the direction of engagement with the second locking element. On the other hand, the center of gravity of the first locking element could be arranged in such a manner that the engagement occurs automatically when the centrifuge rotor is placed on the drive shaft.

In an advantageous further development, it is provided that the first connecting means has at least one chamfer, which serves as a locking aid, wherein the chamfer preferably lies parallel to the longitudinal extension of the lever. This makes the connection construction particularly easy to lock, because it means that the first locking means does not present an obstacle when the centrifuge rotor is fitted onto the drive shaft.

The features and further advantages of the present invention will become apparent below from the description of preferred exemplary embodiments in connection with the figures.

### BRIEF DESCRIPTION OF THE DRAWINGS

FIG. 1 shows the connection construction in a preferred embodiment in the unlocked and separated state in section.

FIG. 2 shows the connection construction according to FIG. 1 in the locked state in section.

FIG. 3 shows the connection construction according to FIG. 1 in the unlocked state in section.

FIG. 4 shows the hub of the centrifuge rotor of the connection construction according to FIG. 1 in a perspective view in section.

FIG. 5 shows the drive shaft of the centrifuge rotor of the connection construction according to FIG. 1 in a perspective view.

FIG. 6 shows the connection construction according to FIG. 1 in detail view in section.

FIG. 7 shows a laboratory centrifuge with the connection construction according to FIG. 1.

### DETAILED DESCRIPTION

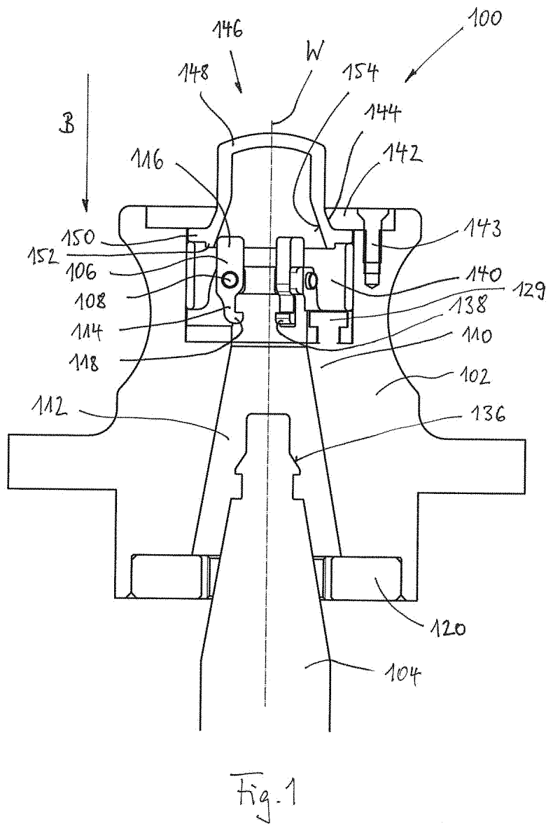

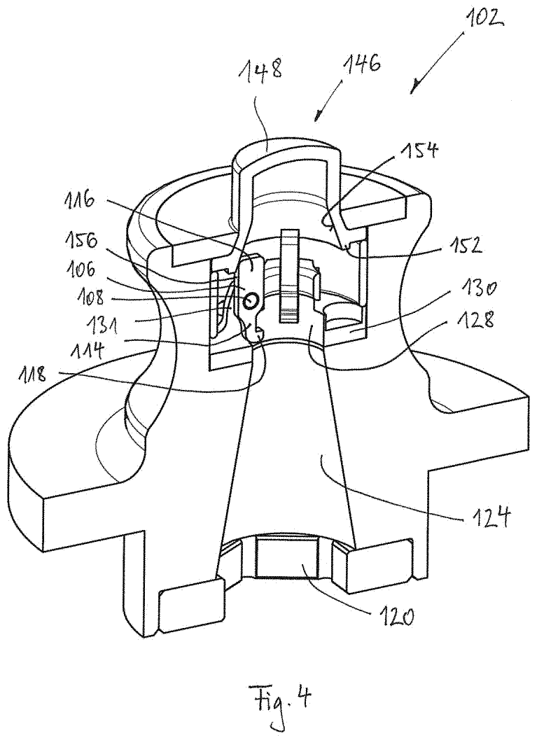

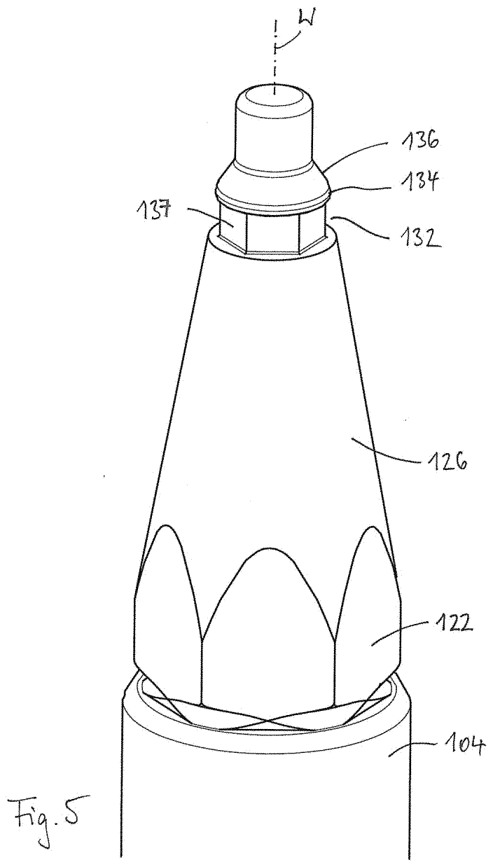

In FIGS. 1 to 6, the connection construction 100 is shown in various views in a preferred embodiment.

It can be seen that the connection construction 100 between a centrifuge rotor 102, which is only partially shown, and a drive shaft 104, which is only partially shown, of a centrifuge motor, which is not shown further, has three levers 106 as first locking elements 106, each of which is pivotably mounted about axes 108.

Such axes 108 are arranged in the hub 110 of the centrifuge rotor 102 such that the levers 106 extend concentrically about a receiving space 112 for the drive shaft 104, each at an angular distance of 120°.

Each of the levers 106 has a lever arm 114 and an actuating arm 116, which are arranged on opposite sides of the axis 108, wherein a hook 118 facing the shaft axis W is arranged on the lever arm 114.

The receiving space 112 for the drive shaft 104 has an incorporated internal hexagon 120, which corresponds to a corresponding external hexagon 122 of the drive shaft 104 and serves to transmit torque. Preferentially, such internal hexagon 120 is made of a harder material than the hub 110 and is fixed in this hub 110, for example screwed in or shrunk in.

The transmission of the torque from drive shaft 104 to centrifuge rotor 102 thus takes place via a positive-locking connection 120, 122. As an alternative to the hexagonal design shown, there could also be another polygonal design, for example an octagonal design, or the positive-locking connection could be made by a tongue-and-groove connection or also a drive pin-and-groove connection or other positive-locking connections that permit torque transmission.

In addition, the hub 110 includes an inner cone 124 that corresponds with a conical section 126 of the drive shaft 104 and serves to provide a perfectly aligned fit of the centrifuge rotor 102 on the drive shaft 104 and a frictional fit. This inner cone 124 merges into an inner cylinder 128, which is formed by a bearing block 130 bolted 129 to the hub 110, on which there exist cantilevers 131 on which the axes 108 are arranged. There could also be preloading means on this bearing block 130, for example in the form of springs (not shown), which effect a preloading of the lever arms 114 with the hooks 118 towards the shaft axis W. However, in the exemplary embodiment shown, such separate preloading means are not provided.

The drive shaft 104 has a groove 132 with an upper projection 134 above the conical section 126, wherein a chamfer 136 extends above the upper projection 134. The projection 134 forms the second locking element.

It can further be seen that the groove 132 has a circumferential configuration in the form of an external hexagon 137, which is oriented parallel to the external hexagon 122. As a result, each hook 118 is always parallel to an associated surface of the external hexagon 137.

The hooks 118 have chamfers 138, which are oriented in the direction of the inner cone 124. In the locked state, the hooks 118 engage in the groove 132 while engaging behind the upper projection 134.

Furthermore, the hub 110 has a cylindrical cavity 140 above the bearing block 130, which is bounded at the top by a lid-shaped closure element 142. In this closure element 142, which can be screwed 143 into the hub 110, for example, there is an aperture 144 in which the actuating element 146 is received in a slidingly displaceable manner.

The actuating element 146 is formed to be sleeve-like, at least in certain areas, and has a body 148 formed as a push button 148, which has a collar 150 in its lower section that projects radially outwards and rests against the closure element 142 in the non-impressed state of the actuating element 146.

A projection 152 is arranged below on the collar 150, wherein, at the transition between the body 148 and the projection 152 opposite the collar 150, there is a section 154 having a conical internal contour, which acts as a contact surface that corresponds to a mating contact surface 156 of the levers 106. The contact surface 154 points in the direction of the shaft axis W, which allows the connection construction to be kept very compact.

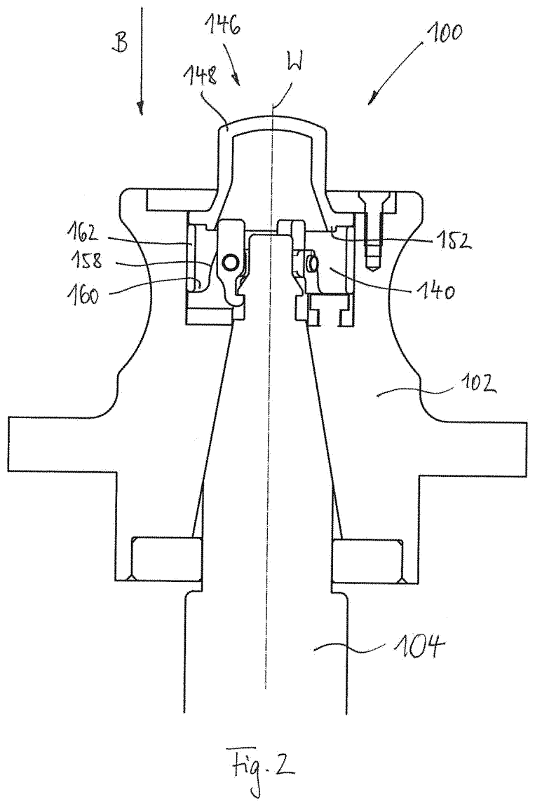

The bearing block 130 has an elevation 158 through the cantilevers 131 to form a recess 160 (see FIG. 2). A coil spring 162 is arranged in such recess 160 on one hand and between the projection 152 and the outer periphery of the cavity 140 on the other hand, and preloads the actuating element 146 in the upward direction, that is, against the actuating direction B of the actuating element 146. The coil spring 162 thereby provides the automatic return of the actuating element 146 from the actuated to the unactuated state.

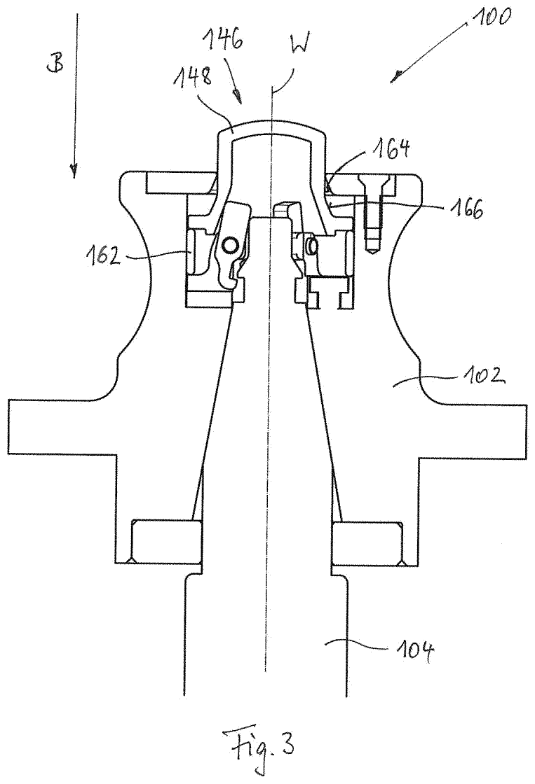

The actuating element 146 can be shifted along an actuating path, that is, it is displaced in the actuating direction B from the unactuated state shown in FIG. 2 to the state moved fully downward shown in FIG. 3.

It can also be seen in FIG. 3 that the aperture 144 has a section 164 having a conical slope, which corresponds to a conical mating section 166 of the actuating element 146. As a result, the tilting of the actuating element 146 is effectively prevented when it is displaced by the coil spring 162 against the actuating direction B.

This connection construction 100 now functions as follows:

In the state shown in FIG. 1, the centrifuge rotor 102 is placed with its hub 110 on the drive shaft 104 of the centrifuge motor. In the process, the hooks 118 come into contact with the chamfer 136 of the drive shaft 104 with their chamfers 138, causing the lever arm 114 to be deflected outward with respect to the shaft axis W until the hooks 118 engage in the groove 132, thereby engaging behind the upper projection 134 (see FIG. 2). Thus, the two chamfers 136, 138 here provide a locking aid by preventing the hooks 118 from jamming or catching on the drive shaft 104.

In order for engagement to occur prior to the operation of the centrifuge rotor 102, the center of mass M of the levers 106 is located in the actuating arm 116, specifically outwardly and upwardly with respect to the axes 108, whereby gravity effects the engagement of the hooks 118 in the groove 132.

The initial position of the levers 106 is bounded by the conical inner surface 154 of the actuating element 146. This prevents the actuating arms 116 from tilting outward and the centrifuge rotor 102 from touching down. Tipping inward is also not a problem, since the drive shaft 104 pushes such levers 106 back into the correct position when the centrifuge rotor 102 is placed on top. However, inward tilting could also be prevented by corresponding contact points in the bearing block 130 (not shown).

During the operation of the centrifuge rotor 102, the center of mass of the levers 106 arranged above the axis 108 causes the actuating arms 116 to move outwardly, pressing the hooks 118 firmly into the groove 132, thereby providing secure locking. Thereby, there is only one displacing element 106, such that the function of the locking is not susceptible to errors.

To release the lock, the push button 148 must be displaced in the actuating direction B, i.e. downward. This brings the contact surface 154 into contact with the mating contact surface 156, which is parallel to the shaft axis W in the unpivoted state.

As the push button 148 is impressed further in the actuating direction B, the mating contact surface 156 slides against the contact surface 154, by which a force on the actuation arms 116 is exerted, by which the hooks 118 are displaced radially outward until they are completely removed from the groove 132 (see FIG. 3).

As a result, the hooks 118 no longer rest against the upper projection 134 and the hub 110 can be pulled off the drive shaft 104, wherein the push button 148 slides upward after it is released by the coil spring 162 until the collar 150 rests against the closure element 142 (see FIG. 1).

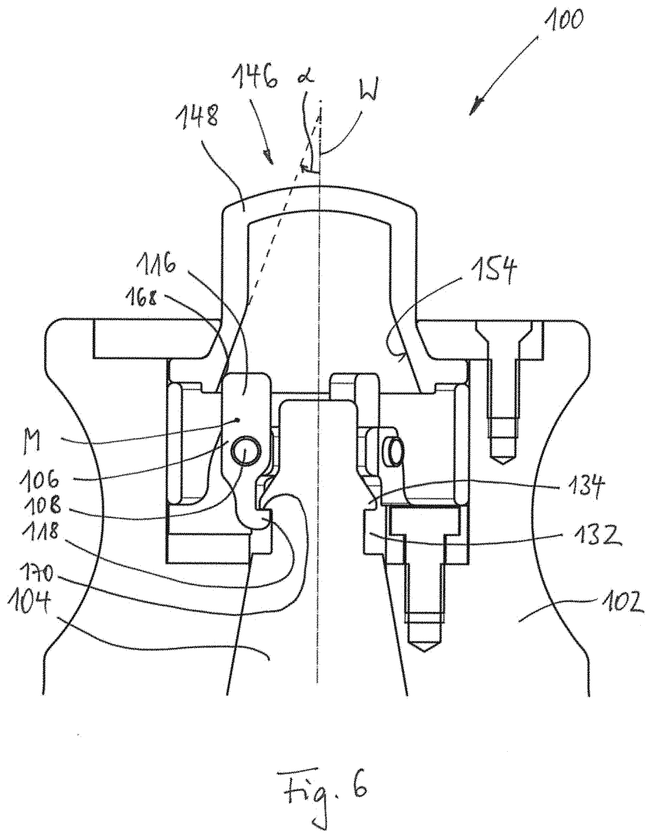

Since the mating contact surface 156 is in contact with the contact surface 146 throughout the actuating path of the actuating means 146, a very secure unlocking occurs. The unlocking will also take place in a highly secure and trouble-free manner, because the distance of an outer point 168 of the actuating arm 116 from the axis 108 is greater than or equal to the distance of a locking point 170 of the lever arm 114 from the axis 108 (see FIG. 6); at that point, large lever forces can thereby be transmitted to the lever arm 114. This is further aided by the fact that the contact surface 154 has a slope a in the range of 35° to 55° with respect to the shaft axis W, by which a large force transmission with short actuating travels of the actuating means 146 is enabled.

Although an example has been shown above, with which levers 106 that pivot about an axis 108 have been used, levers 106 that pivot about an axis and are arranged on the drive shaft may also be used.

Furthermore, the actuating element 146 also does not necessarily have to be arranged on the hub 110 of the centrifuge rotor 102; it can also be arranged on the drive shaft.

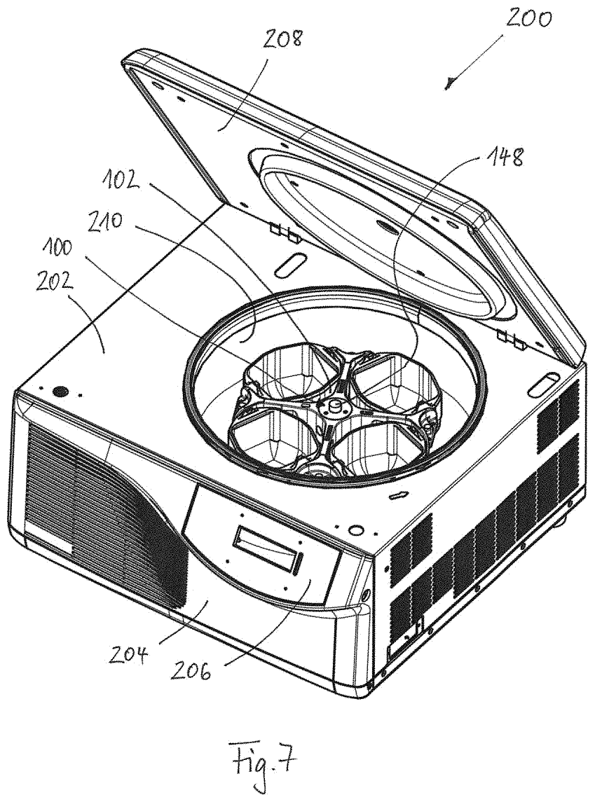

FIG. 7 shows a laboratory centrifuge 200 equipped with the connection construction 10.

It can be seen that such laboratory centrifuge 200 is formed in the usual manner, and thereby has a housing 202 with a control panel 206 arranged at its front side 204 and a lid 208, which is provided for closing the centrifuge container 210. A fixed-angle rotor 12 is arranged in the centrifuge container 210 as a centrifuge rotor, which can be driven by the drive shaft of a centrifuge motor (both not shown).

From the foregoing illustration, it has become clear that the present invention provides a connection construction 100 between the centrifuge rotor 102 and the drive shaft 104 of a laboratory centrifuge 200, which allows one-handed operation that does not require any additional tools. In this connection, the connection structure 100 is constructed in such a manner that the locked state 118, 132, 134 is always ensured, wherein the jamming or blocking of locking elements 118, 132, 134 cannot take place.

Unless otherwise indicated, all features of the present disclosure can be freely combined. Also, unless otherwise indicated, the features described in the description of the figures can be freely combined with the other features. A limitation of individual features of the exemplary embodiments to the combination with other features of the exemplary embodiments is expressly not intended. In addition, the features of the subject matter can also be reformulated and used as method features, and the method features can be reformulated and used as features of the subject matter. Such a reformulation is thus automatically disclosed.

### LIST OF REFERENCE SIGNS

100 Connection construction in a preferred embodiment

102 Centrifuge rotor

104 Drive shaft

106 Lever, first locking elements

108 Axes of the lever 106

110 Hub

112 Receiving space for the drive shaft

114 Lever arm

116 Actuating arm

118 Hook

120 Internal hexagon of the hub 110

122 External hexagon of the drive shaft 104

124 Inner cone of the hub 110

126 Conical section of the drive shaft 104

128 Inner cylinder of the hub 110

129 Screwing of the bearing block 130 to the hub 110

130 Bearing block

131 Cantilever on the bearing block 130 for axes 108

132 Groove

134 Upper projection of the groove 132, second locking element

136 Chamfer on drive shaft 104

137 Circumferential configuration of the groove 132 in the form of an external hexagon

138 Chamfer on the hook 118

140 Cylindrical cavity of the hub

142 Lid-shaped closure element

143 Screwing of the closure element 142 to the hub 110

144 Aperture

146 Actuating element

148 Push button, body of actuating element 146

150 Collar

152 Projection

154 Section with conical inner contour, contact surface

156 Mating contact surface of the lever 106 on actuating arm 116

158 Elevation of the bearing block 130

160 Recess

162 Coil spring

164 Section with conical slope of the aperture 144

166 Conical mating section of the actuating element 146

168 Outer point of the actuating arm 116

170 Locking point of the lever arm 114

200 Laboratory centrifuge

202 Housing

204 Front side of the housing 202

206 Control panel

208 Lid

210 Centrifuge container

α Slope of the contact surface 154 with respect to the shaft axis W

B Actuating direction of the actuating element 146

M Center of mass of the lever 106

W′ Shaft axis

1.-18. (canceled)

19. A connection construction (100) between a centrifuge rotor (102) and a drive shaft (104) of a centrifuge motor, the drive shaft (104) extending along a shaft axis (W), wherein
a first locking element (106) is arranged on one of the elements of the centrifuge rotor (102) and the drive shaft (104), and
a second locking element (134) is arranged on another of the elements of the centrifuge rotor (102) and the drive shaft (104),
wherein the first locking element (106) is engaged with the second locking element (134) in a locked state of the connection and is disengaged in an unlocked state,
wherein there is an actuating means (146) on one of the elements of the centrifuge rotor (102) and the drive shaft (104), an actuation of which causes the first locking element (106) to disengage from the second locking element (134), whereby the centrifuge rotor (102) is removable from the drive shaft (104).

20. The connection construction (100) according to claim 19,
wherein the first locking element is a lever (106) having a lever arm (114) which is movable in a plane including the shaft axis (W).

21. The connection construction (100) according to claim 20,
wherein the lever (106) is pivotally mounted about an axis (108).

22. The connection construction (100) according to claim 21,
wherein the lever (106) has an actuating arm (166) arranged opposite from the lever arm (114),
wherein the axis (108) is arranged between the lever arm (114) and the actuating arm (116).

23. The connection construction (100) according to claim 22,
wherein a distance of an outer point of the actuating arm (116) from the axis (108) is greater than or equal to a distance of a locking point of the lever arm (114) from the axis (108).

24. The connection construction (100) according to claim 22,
wherein the first locking element (106) is formed such that it engages with the second locking element (134) under the influence of centrifugal force,
wherein a center of mass of the first locking element (106) is located in the actuating arm (114).

25. The connection construction (100) according to claim 19,
wherein the actuating means (146) has a contact surface (154) for a mating contact surface (156) of the first locking element (106),
wherein one of the two surfaces contact surface (154) and mating contact surface has an inclined course in the actuating direction (B) of the actuating means (146), at least in the locked state of the connection construction (100), in such a manner such that an actuation of the actuating means (146) causes the first locking element (106) to pivot,
wherein the contact surface (154) runs in a manner inclined in an axial direction of the shaft axis (W) and/or pointing towards the shaft axis (W).

26. The connection construction (100) according to claim 25,
wherein the contact surface (154) has a slope (α) in the range of 35° to 55° with respect to the shaft axis (W).

27. The connection construction (100) according to claim 25,
wherein the actuating means (146) is formed to be sleeve-like at least in certain areas,
wherein the contact surface (154) is arranged on an inner side of the actuating means (146).

28. The connection construction (100) according to claim 25,
wherein the actuating means (146) can be actuated along an actuating path,
wherein the contact surface (146) is formed such that the mating contact surface (156) bears against it over the entire actuating path.

29. The connection construction (100) according to claim 19,
wherein the actuating means (146) is formed as a push button (148) that is preloaded (162) against the actuating direction (B).

30. The connection construction (100) according to claim 19,
wherein the first locking element (106) is arranged on the centrifuge rotor (102).

31. The connection construction (100) according to claim 19,
wherein the second locking element (134) is a projection (134) of the drive shaft (104), which the first locking element (106) engages behind in the locked state.

32. The connection construction (100) according to claim 19,
wherein the actuating means (146) is arranged on the centrifuge rotor (102).

33. The connection construction according to claim 19,
wherein the connection construction provides a snap-in connection,
wherein the locking takes place within a clip connection, which is designed to be releasable.

34. The connection construction (100) according to claim 19,
wherein there are at least two first locking elements (106).

35. The connection construction according to claim 19,
wherein the first locking element is preloaded in a direction of engagement with the second locking element.

36. The connection construction (100) according to claim 20,
wherein the first connecting element (106) has at least one chamfer (138), which serves as a locking aid,
wherein the chamfer (138) lies parallel to the longitudinal extension of the lever (106).

37. A connection (100) between a centrifuge rotor (102) and a drive shaft (104), comprising:
a lever (106) arranged on the centrifuge rotor (102), the lever being pivotable about an axis (108) and having an actuating arm (116) above the pivot axis and a lever arm (114) below the pivot axis;
a projection (134) formed in the drive shaft (104), behind which the lever (106) engages in a locked state of the connection; and
a push button (148) having a conical contact surface (154) which, when the push button (148) is pushed down, presses against a mating contact surface (156) on the actuating arm (116), causing the lever (106) to pivot and the lever arm (114) to disengage from the projection (134), whereby the centrifuge rotor (102) is removable from the drive shaft (104).
